(19) United States
(12) Patent Application Publication
(10) Pub. No.: US 2024/0217046 A1
(43) Pub. Date: Jul. 4, 2024

(54) SHIELD HOLDER

(71) Applicant: SHIN-YAIN INDUSTRIAL CO., LTD., Taichung City (TW)

(72) Inventor: PEN HUNG CHEN, TAICHUNG CITY (TW)

(21) Appl. No.: 18/090,546

(22) Filed: Dec. 29, 2022

(51) Int. Cl. B23Q 11/08

(52) U.S. Cl. CPC B23Q 11/0883

(57) ABSTRACT

A shield holder is configured to be detachably connected to a spindle of a machining tool and has a connection portion configured to be detachably connected to the spindle and a shield portion formed at an end of the connection portion. The shield portion includes a shield body integrally formed with the connection portion and a cushion layer formed on and covering a surface of the shield body. After a workpiece is processed, the shield holder is substituted for a cutter holder and is connected to the spindle for blocking the workpiece pushed out from a clamping device to prevent the workpiece from damage.

### BACKGROUND OF THE INVENTION

### 1. Field of the Invention

The present invention relates to an accessory for a machining tool, and more particularly to a shield holder configured to be connected to a spindle of a machining tool to block and protect a workpiece from being pushed out from a clamping device.

### 2. Description of Related Art

A conventional machining tool, such as a lathe, substantially comprises a spindle, a cutter holder mounted on the spindle, and a clamping device for clamping a workpiece.

The clamping device has a horizontal central axis and multiple clamping components arranged around the central axis. The clamping components are slid toward the central axis to clamp the workpiece and are slid away from the central axis to release the workpiece.

A pushing component may be disposed in the clamping device for pushing out the workpiece from the clamping device. The pushing component extends along the central axis of the clamping device and is movable along the central axis relative to the clamping device to push the workpiece. When the clamping components of the clamping device slide from the workpiece to release the workpiece, the pushing component slides toward the workpiece to push the workpiece out from the clamping device. However, if the workpiece is not received by a staff staying aside while the workpiece is being pushed out from the clamping device by the pushing component with an excessive force, the workpiece is prone to hit against a hard surface of the machining tool and get damaged.

To overcome the shortcomings, the present invention tends to provide a shield holder to mitigate or obviate the aforementioned problems.

### SUMMARY OF THE INVENTION

The main objective of the invention is to provide a shield holder configured to be mounted to a spindle of a machining tool for blocking workpieces. After a workpiece is processed, the shield holder can be connected to the spindle to be substituted for a cutter holder for gently stopping the workpiece pushed out from a clamping device by a pushing device.

The shield holder is configured to be detachably connected to a spindle of a machining tool and has a connection portion configured to be detachably connected to the spindle and a shield portion formed at an end of the connection portion. The shield portion includes a shield body integrally formed with the connection portion and a cushion layer formed on and covering a surface of the shield body.

Other objects, advantages and novel features of the invention will become more apparent from the following detailed description when taken in conjunction with the accompanying drawings.

### BRIEF DESCRIPTION OF THE DRAWINGS

FIG. 1 is a partial front view of a machining tool showing a shield holder in accordance with the present invention connected to a spindle of the machining tool;

FIG. 2 is a partially enlarged perspective view of the machining tool in FIG. 1, showing the shield holder connected to the spindle of the machining tool;

FIG. 3 is another enlarged perspective view of the machining tool in FIG. 1, showing the shield holder connected to the spindle of the machining tool;

FIG. 4 is an enlarged front view in partial section of the shield holder and a clamping device connected in FIG. 1;

FIG. 5 is a perspective view of the shield holder in FIG. 1;

FIG. 6 is a cross sectional side view of the shield holder in FIG. 5;

FIG. 7 is a cross sectional end view of the shield holder along line 7-7 in FIG. 6; and

FIG. 8 is an enlarged operational front view of the machining tool in FIG. 1, showing a workpiece blocked by the shield holder connected to the spindle of the machining tool.

### DETAILED DESCRIPTION OF PREFERRED EMBODIMENT

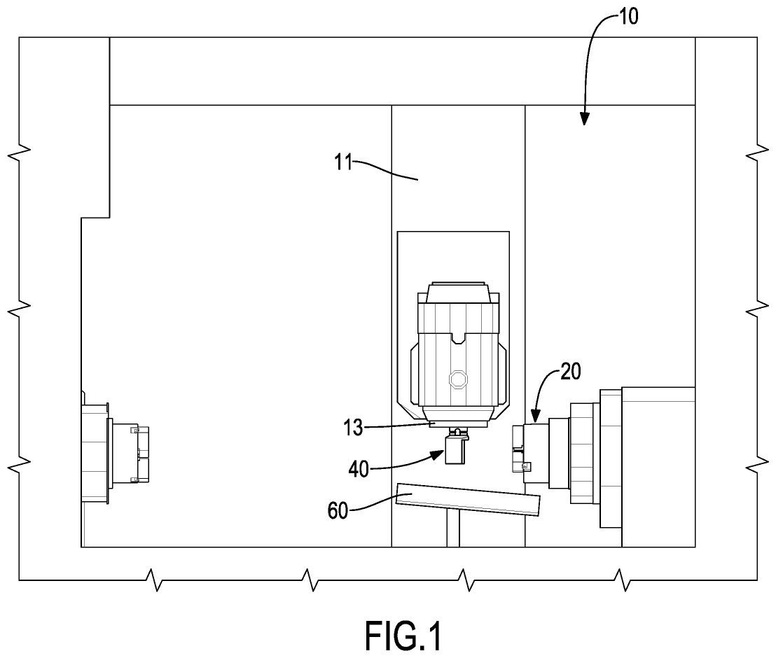

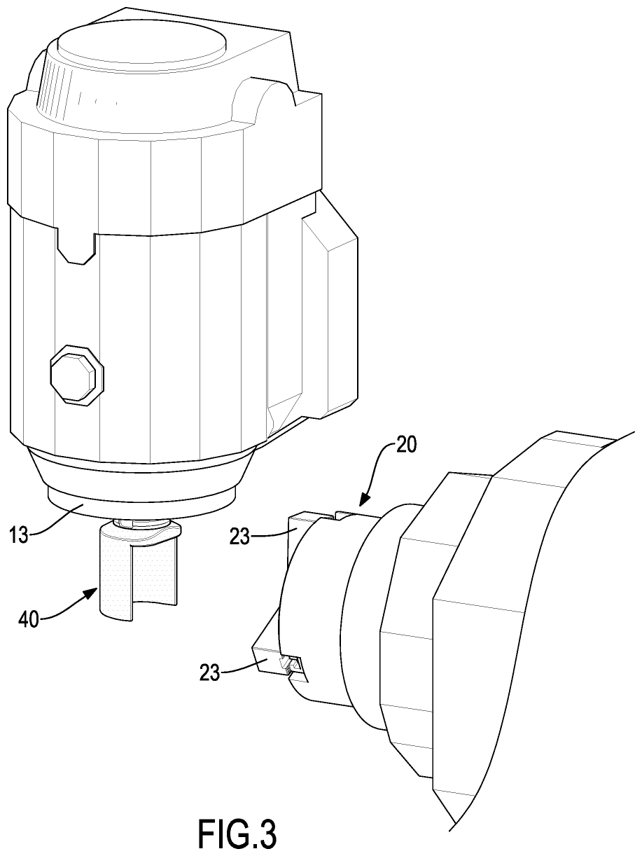

With reference to FIGS. 1 to 4, a shield holder 40 in accordance with the present invention is configured to be connected to a spindle 13 of a machining tool. The machining tool substantially comprises a tool body 10, a clamping device 20, and a pushing device 30.

With reference to FIG. 1, the tool body 10 comprises a base 11. The spindle 13 is movably connected to the base 11. The clamping device 20 is disposed at a side of the tool body 10.

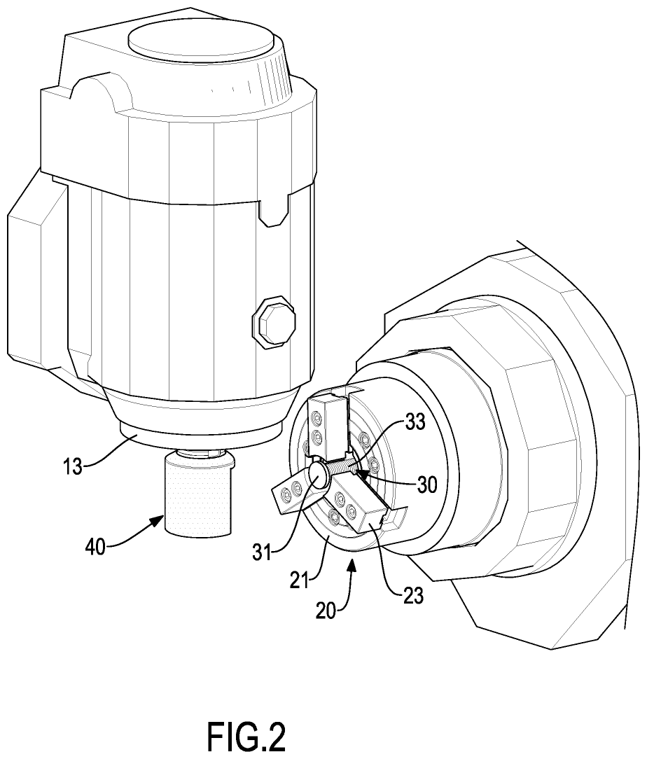

With reference to FIGS. 2 to 4, the clamping device 20 comprises a central axis A, a clamping base 21, and multiple clamping components 23. The central axis A extends along a horizontal direction. The multiple clamping components 23 are radially arranged, surround the central axis A, are connected to the clamping base 21, and are capable of radially sliding toward and away from the central axis A. The clamping device 20 can be rotated around the central axis A, so the workpiece can be rotated with the clamping device 20 during processing.

With reference to FIGS. 2 to 4, the pushing device 30 is connected to the clamping base 21 of the clamping device 20 and comprises a pushing rod 31 and a spring 33. The pushing rod 31 is able to extend and retract relative to the clamping base 21 along the central axis A. The spring 33 is disposed between the pushing rod 31 and the clamping device 20 to push the pushing rod 31 away from the clamping base 21.

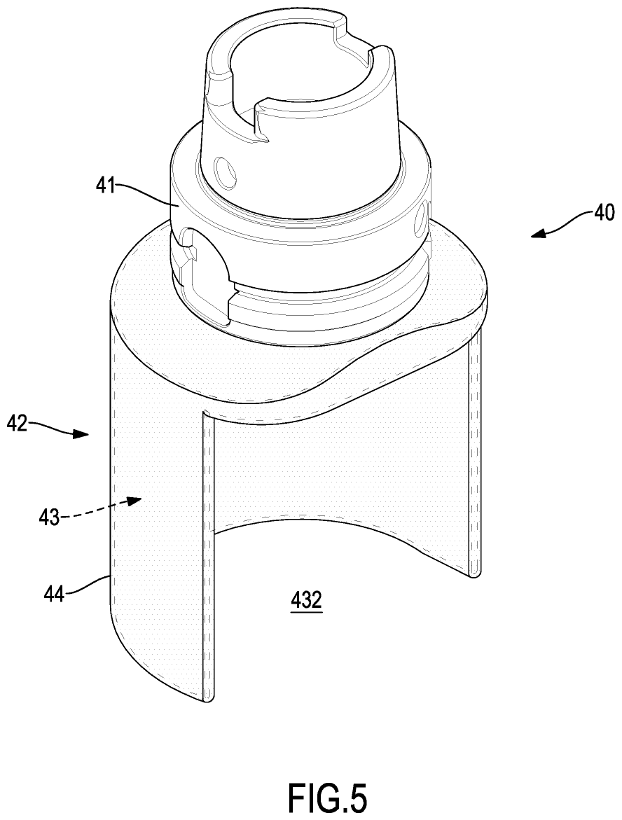

With reference to FIGS. 2 to 5, the shield holder 40 is detachably connected to the spindle 13. A spindle axis of the spindle 13 is perpendicular to the central axis A of the clamping device 20. In the embodiment, the spindle 13 extends vertically. The shield holder 40 comprises a connection portion 41 and a shield portion 42. The connection portion 41 is configured to be detachably connected to the spindle 13. A structure of the connection portion 41 may be same as a structure of a connection portion of a conventional cutter holder for being connected to the spindle 13, and detail thereof is omitted.

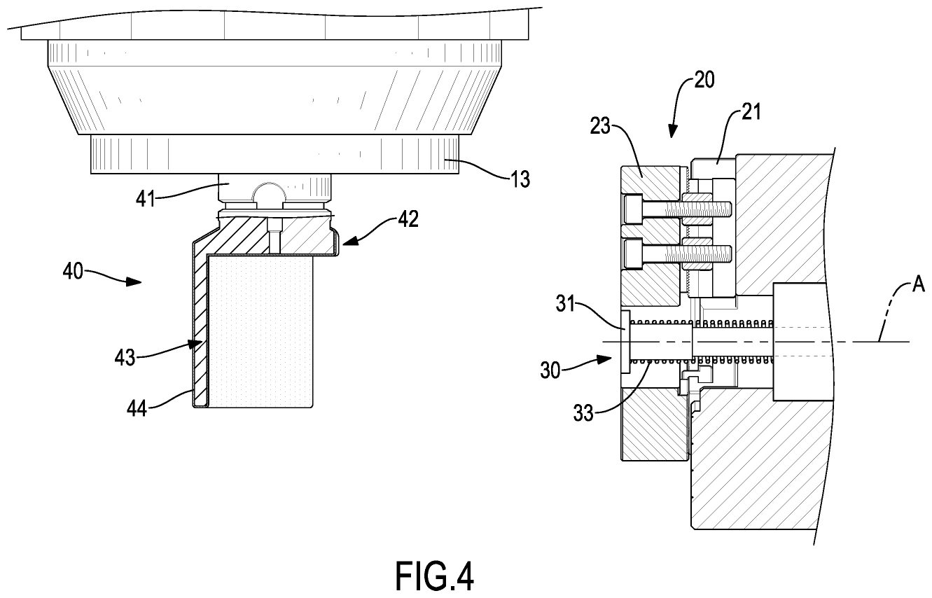

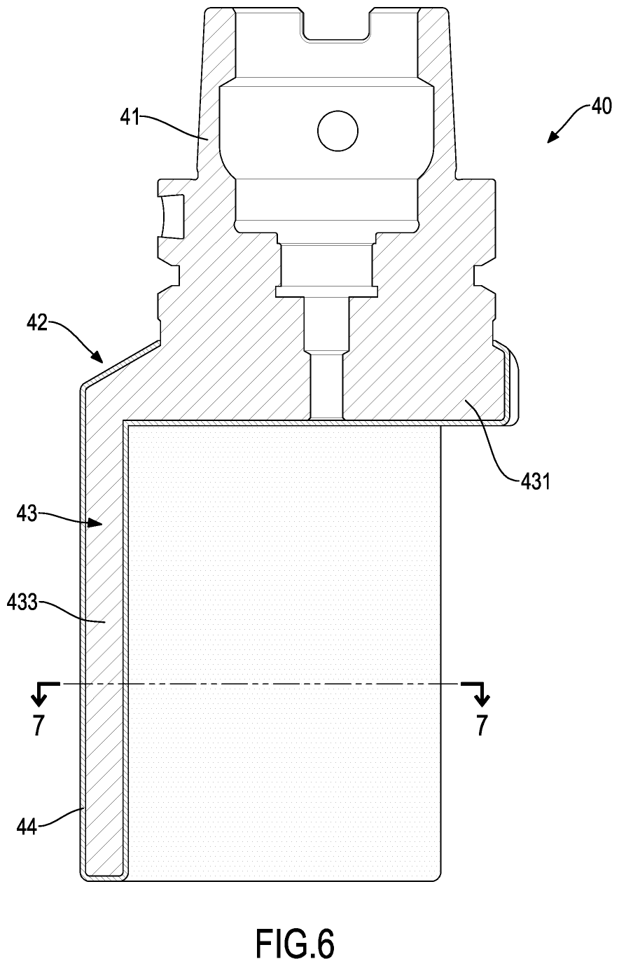

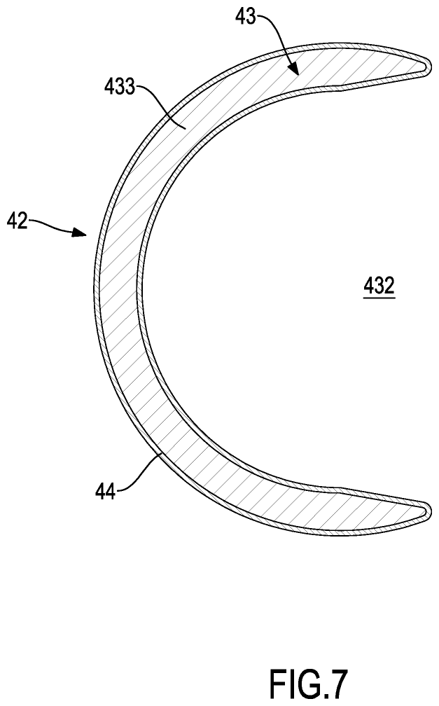

With reference to FIGS. 4 to 7, the shield portion 42 is formed at an end of the connection portion 41 disposed away from the spindle 13. The shield portion 42 includes a shield body 43 and a cushion layer 44. The shield body 43 is integrally formed with the connection portion 41. The cushion layer 44 is formed on and covers on a surface of the shield body 43. The shield body 43 and the connection portion 41 are integrally made of metal. The cushion layer 44 is made of elastomer, e.g., rubber, silicone rubber, and thermoplastic elastomer, formed on and covering the surface of the shield body 43. In the embodiment, the cushion layer 44 is made of flexible polyvinyl chloride (flexible PVC).

The shield body 43 includes a top portion 431 and a surrounding portion 433. The top portion 431 has an end surface facing away from the connection portion 41. The surrounding portion 433 extends away from the connection portion 41 from the end surface of the top portion 431. The surrounding portion 433 is curved, and bends along an outer edge of the top portion 431 to form a notch 432 facing the clamping device 20 at a concave side of the surrounding portion 433. The cushion layer 44 is formed on and covers entire surface of the surrounding portion 433 and the end surface of the top portion 431.

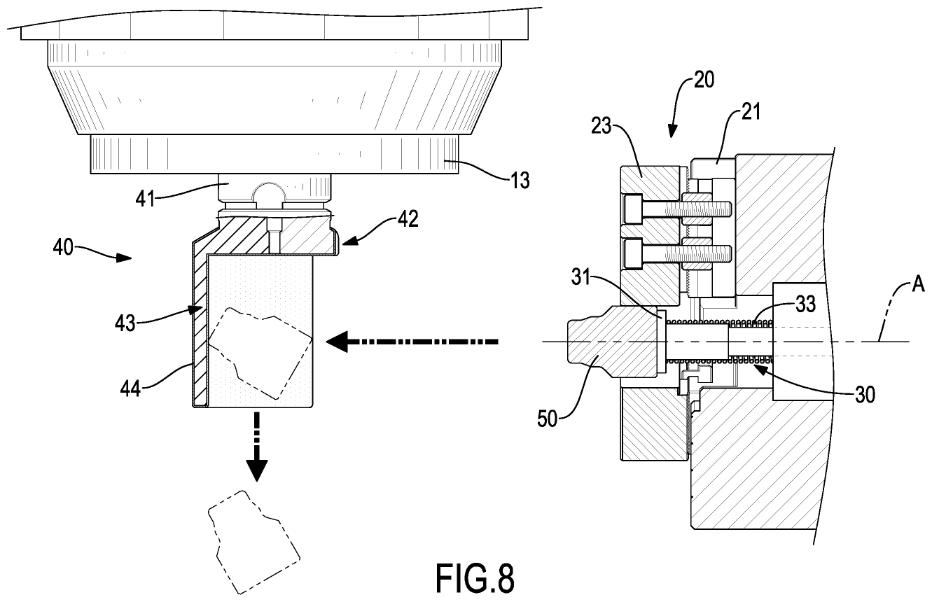

With reference to FIG. 8, when the workpiece 50 is clamped by the clamping device 20, the workpiece 50 is placed between the clamping components 23 and pushes the pushing rod 31 backwardly to compress the spring 33, and the clamping components 23 slide toward the workpiece 50 to clamp the workpiece 50. After the workpiece 50 is processed by a cutter holder with a cutter connected to the spindle 13, the shield holder 40 is substituted for the cutter holder to be connected to the spindle 13. An automatic tool changer (ATC) may be included in the machining tool. After the workpiece 50 is processed, the automatic tool changer is driven to remove the cutter holder from the spindle 13 and assemble the shield holder 40 to the spindle 13, automatically. The spindle 13 can be controlled to move to a position where the shield holder 40 is located in front of the clamping device 20 and faces the workpiece 50 directly. After that, the clamping device 20 is controlled to release the workpiece 50 and the spring 33 pushes the pushing rod 31 extending out from the clamping device 20. The workpiece 50 is pushed and shot out from the clamping device 20 by the pushing rod 31, and then hits the shield portion 42 of the shield holder 40. The workpiece 50 is stopped by the shield holder 40, accordingly. The cushion layer of the shield portion 42 provides the workpiece 50 with buffering effect to absorb impact force from the workpiece 50. Therefore, the workpiece 50 is prevented from damage while hitting the shield portion 42.

With reference to FIGS. 1 and 8, a receiving box 60 can be placed below the spindle 13 and the shield holder 40. The workpiece 50 can directly drop into the receiving box 60 after being stopped by the shield holder 40.

As the shield holder 40 is detachably connected to the spindle 13 and is connected to the spindle 13 after the workpiece 50 is processed, the traffic flow of the cutter holder for processing the workpiece 50 is free from being interfered by the shield holder 40. The shield holder 40 can be moved with the spindle 13 without equipping an additional moving device with the machining tool for moving the shield holder 40 to a proper position for blocking the workpiece 50 pushed out from the clamping device 20 by the pushing device 30. The shield portion 42 of the shield holder 40 includes the cushion layer 44 for cushioning and absorbing impact force to avoid damaging the workpiece 50.

The shield holder 40 is suitable for the machining tool including an automatic tool changer. After the workpiece 50 is processed, the shield holder 40 is substituted for the cutter holder by the automatic tool changer automatically. After released from the clamping device 20, the workpiece 50 is automatically pushed out from the clamping device 20 by the pushing rod 31, and then is gently stopped and cushioned by the shield holder 40. Therefore, the workpiece 50 can be automatically pushed out from the clamping device 20, be gently stopped and cushioned by the shield holder 40, and is prevented from getting damaged via hitting a rigid component of the machining tool. The convenience of the machining tool is improved.

What is claimed is:

1. A shield holder configured to be detachably connected to a spindle of a machining tool and comprising:
a connection portion configured to be detachably connected to the spindle; and
a shield portion formed at an end of the connection portion and including:
a shield body integrally formed with the connection portion; and
a cushion layer formed on and covering a surface of the shield body.

2. The shield holder as claimed in claim 1, wherein the shield body includes:
a top portion having an end surface facing away from the connection portion; and
a surrounding portion extending away from the connection portion from the end surface of the top portion and being curved to form a notch at a concave side of the surrounding portion.

3. The shield holder as claimed in claim 2, wherein the cushion layer is entirely formed on and covers a surface of the surrounding portion of the shield body.

4. The shield holder as claimed in claim 3, wherein the cushion layer is formed on and covers the end surface of the top portion of the shield body.

5. The shield holder as claimed in claim 1, wherein
the shield body and the connection portion are integrally made of metal; and
the cushion layer is made of elastomer formed on and covering the surface of the shield body.

6. The shield holder as claimed in claim 2, wherein
the shield body and the connection portion are integrally made of metal; and
the cushion layer is made of elastomer formed on and covering the surface of the shield body.

7. The shield holder as claimed in claim 3, wherein
the shield body and the connection portion are integrally made of metal; and
the cushion layer is made of elastomer formed on and covering the surface of the shield body.

8. The shield holder as claimed in claim 4, wherein
the shield body and the connection portion are integrally made of metal; and
the cushion layer is made of elastomer formed on and covering the surface of the shield body.

9. The shield holder as claimed in claim 5, wherein the cushion layer is a thermoplastic elastomer.

10. The shield holder as claimed in claim 6, wherein the cushion layer is a thermoplastic elastomer.

11. The shield holder as claimed in claim 7, wherein the cushion layer is a thermoplastic elastomer.

12. The shield holder as claimed in claim 8, wherein the cushion layer is a thermoplastic elastomer.
